(19) United States
(12) Patent Application Publication
(10) Pub. No.: US 2025/0112679 A1
(43) Pub. Date: Apr. 3, 2025

(54) BEAM SELECTION METHOD, TERMINAL, AND NETWORK SIDE DEVICE

(71) Applicant: VIVO MOBILE COMMUNICATION CO., LTD., Dongguan (CN)

(72) Inventors: Qi HONG, Dongguan (CN); Chenxi WANG, Dongguan (CN); Gen LI, Dongguan (CN)

(73) Assignee: VIVO MOBILE COMMUNICATION CO., LTD., Dongguan (CN)

(21) Appl. No.: 18/981,441

(22) Filed: Dec. 13, 2024

Related U.S. Application Data
(63) Continuation of application No. PCT/CN2023/100378, filed on Jun. 15, 2023.

(30) Foreign Application Priority Data
Jun. 15, 2022 (CN) 202210680851.X

(51) Int. Cl. H04B 7/06; H04W 16/28; H04W 52/02

(52) U.S. Cl. CPC H04B 7/0617; H04W 16/28; H04W 52/0206

(57) ABSTRACT

This application provides a beam selection method, a terminal, and a network side device. The beam selection method includes: a User equipment (UE) sends one or more preambles to a first cell when the first cell is a to-be-woken-up cell, the UE determines a first beam based on first information, and the UE transmits data on the first beam. The first cell is different from a serving cell of the UE. The first information is related to the one or more preambles.

### CROSS-REFERENCE TO RELATED APPLICATIONS

This application is a continuation of International Application No. PCT/CN 2023/100378, filed on Jun. 15, 2023, which claims priority to Chinese Patent Application No. 202210680851.X filed in China on Jun. 15, 2022. The entire contents of each of the above-referenced applications are expressly incorporated herein by reference.

### TECHNICAL FIELD

This application relates to the field of communication technologies, and specifically, to a beam selection method, a terminal, and a network side device.

### BACKGROUND

In a network energy saving technology, there may be a possibility that in network deployment, some base stations are in closed states to save energy. In this case, based on various reasons, such as a data requirement of user equipment UE and a requirement on a network side, it is necessary to wake up one or more closed base stations. In the related art, generally, the UE in a current serving cell sends a wake-up signal to wake up the closed base station.

However, in a scenario in which the base station is woken up, a beam connection between the woken-up base station and the UE needs to be considered.

### SUMMARY

Embodiments of this application provide a beam selection method.

According to a first aspect, a beam selection method is provided, applied to a terminal. The method includes: User equipment UE sends N preamble(s) to a first cell when the first cell is a to-be-woken-up cell, where the first cell is different from a serving cell of the UE. The UE determines a first beam based on first information, where the first information is related to the N preamble(s). The UE transmits data on the first beam.

According to a second aspect, a beam selection apparatus is provided. The apparatus includes a sending module, a processing module, and a transmission module. The sending module is configured to send N preamble(s) to a first cell when the first cell is a to-be-woken-up cell, where the first cell is different from a serving cell of UE. The processing module is configured to determine a first beam based on the first information, where the first information is related to the N preamble(s). The transmission module is configured to transmit data on the determined first beam.

According to a third aspect, a beam selection method is provided, applied to a network side device. The method includes: A first network side device receives N preamble(s) sent by UE. The first network side device determines a first beam based on the N preamble(s). The first network side device sends first information to a second network side device; where the first information is configured for indicating the first beam, the first network side device is in an energy saving mode, and a cell corresponding to the second network side device includes a serving cell of the UE.

According to a fourth aspect, a beam selection apparatus is provided. The receiving module is configured to receive N preamble(s) sent by UE. The processing module is configured to determine a first beam based on the N preamble(s). The sending module is configured to send first information to a second network side device; where the first information is configured for indicating the first beam, and a cell corresponding to the second network side device includes a serving cell of the UE.

According to a fifth aspect, a terminal is provided. The terminal includes a processor and a memory. The memory stores a program or an instruction executable on the processor. When the program or the instruction is executed by the processor, steps of the method according to the first aspect are implemented.

According to a sixth aspect, a terminal is provided, including a processor and a communication interface. The communication interface is configured to send N preamble(s) to a first cell when the first cell is a to-be-woken-up cell, where the first cell is different from a serving cell of UE. The processor is configured to determine a first beam based on first information, where the first information is related to the N preamble(s). The UE transmits data on the first beam.

According to a seventh aspect, a network side device is provided. The network side device includes a processor and a memory. The memory stores a program or an instruction executable on the processor. When the program or the instruction is executed by the processor, steps of the method according to the first aspect are implemented.

According to an eighth aspect, a network side device is provided. The network side device is a first network side device, and includes a processor and a communication interface. The communication interface is configured to receive N preamble(s) sent by UE. The processor is configured to determine a first beam based on the N preamble(s). The communication interface is further configured to send first information to a second network side device; where the first information is configured for indicating the first beam, the first network side device is in an energy saving mode, and a cell corresponding to the second network side device includes a serving cell of the UE.

According to a ninth aspect, a communication system is provided, including a terminal and a network side device. The terminal may be configured to perform steps of the beam selection method according to the first aspect. The network side device may be configured to perform steps of the beam selection method according to the third aspect.

According to a tenth aspect, a readable storage medium is provided. The readable storage medium stores a program or an instruction. When the program or the instruction is executed by a processor, steps of the method according to the first aspect or steps of the method according to the third aspect are implemented.

According to an eleventh aspect, a chip is provided. The chip includes a processor and a communication interface. The communication interface is coupled to the processor, and the processor is configured to run a program or an instruction to implement the method according to the first aspect, or implement the method according to the third aspect.

According to a twelfth aspect, a computer program/program product is provided. The computer program/program product is stored in a storage medium. The computer program/program product is executed by at least one processor to implement steps of the beam selection method according to the first aspect or steps of the beam selection method according to the third aspect.

In embodiments of this application, the UE sends the N preamble(s) to the first cell when the first cell is the to-be-woken-up cell, where the first cell is different from the serving cell of the UE; the UE determines the first beam based on the first information, where the first information is related to the N preamble(s); and the UE transmits data on the first beam. In this way, the UE may send the N preamble(s) to a to-be-woken-up first cell, to obtain the first information and determine the first beam, and then may transmit the data on the first beam.

### BRIEF DESCRIPTION OF THE DRAWINGS

FIG. 1 is a schematic diagram of a possible structure of a communication system according to an embodiment of the present disclosure;

FIG. 2 is a schematic diagram 1 of time-frequency resource mapping according to an embodiment of this application;

FIG. 3 is a schematic diagram 2 of time-frequency resource mapping according to an embodiment of this application;

FIG. 4 is a schematic diagram 3 of time-frequency resource mapping according to an embodiment of this application;

FIG. 5 is a schematic diagram 4 of time-frequency resource mapping according to an embodiment of this application;

FIG. 6 is a schematic flowchart 1 of a beam selection method according to an embodiment of this application;

FIG. 7a-FIG. 7d are schematic diagrams 5 of time-frequency resource mapping according to an embodiment of this application;

FIG. 8 is a schematic flowchart 2 of a beam selection method according to an embodiment of this application;

FIG. 9 is a schematic diagram 1 of a structure of a beam selection apparatus according to an embodiment of this application;

FIG. 10 is a schematic diagram 2 of a structure of a beam selection apparatus according to an embodiment of this application;

FIG. 11 is a schematic diagram 3 of a structure of a beam selection apparatus according to an embodiment of this application;

FIG. 12 is a schematic diagram 4 of a structure of a beam selection apparatus according to an embodiment of this application;

FIG. 13 is a schematic diagram 5 of a structure of a beam selection apparatus according to an embodiment of this application;

FIG. 14 is a schematic diagram of a hardware structure of a communication device according to an embodiment of this application;

FIG. 15 is a schematic diagram of a hardware structure of an electronic device according to an embodiment of this application; and

FIG. 16 is a schematic diagram of a hardware structure of a network side device according to an embodiment of this application.

### DETAILED DESCRIPTION

The following clearly describes the technical solutions in embodiments of this application with reference to the accompanying drawings in embodiments of this application. It is clear that, the described embodiments are some of embodiments of this application rather than all of embodiments. All other embodiments obtained by a person of ordinary skill in the art based on embodiments of this application shall fall within the protection scope of this application.

The terms “first”, “second”, and the like in the specification and claims of this application are used to distinguish between similar objects, but are not used to describe a specific sequence or order. It may be understood that the terms used in such a way are interchangeable in proper circumstances, so that embodiments of this application can be implemented in sequences other than the sequence illustrated or described herein. Objects distinguished by using “first” and “second” are generally of one class, and a quantity of the objects are not limited. For example, there may be one or more first objects. In addition, “and/or” in the specification and the claims represents at least one of connected objects, and the character “/” generally represents an “or” relationship between associated objects.

The following describes technical terms involved in the technical solutions provided in embodiments of this application.

### Beam

Due to shortage of low-frequency resources, a high frequency band for data transmission is used in the 5G standard, such as a millimeter wave. Because a transmission loss of the high frequency band is larger than a transmission loss of a low frequency band, a coverage distance of the high frequency band is less than a coverage distance of the LTE standard. Signal is enhanced in a multi-antenna beam forming manner in the 5G, to enhance coverage. Currently, the beam forming is a signal processing technology that uses a sensor array to directionally send and receive a signal. In a beam forming technology, a parameter of a basic element of a phased array is adjusted, so that constructive interference is performed on signals at some angles, and destructive interference is performed on signals at other angles. Therefore, an antenna beam points to a specific direction. Establishment of a downlink beam is generally determined through a Synchronization Signal Block (SSB) and a Channel State Information-Reference Signal (CSI-RS).

The SSB is used as an example. Because the beam is narrow, in the standard, a same SSB is sent to different directions in a form of a beam in a Time Division Duplex (TDD) manner, so that UE in each direction can receive the SSB. In a range of 5 ms, a base station sends a plurality of SSBs (corresponding to different SSB subscripts) to cover different directions respectively. The UE receives a plurality of SSBs with different signal strength, and selects a strongest SSB beam as the SSB beam of the UE.

The beam is used in an NR random access procedure. The SSB has a plurality of sending opportunities in a time domain periodicity, and has corresponding numbers, where the numbers can correspond to different beams respectively. However, for the UE, only when a beam scan signal of the SSB covers the UE, the UE has an opportunity to send a preamble. When receiving the preambles of the UE, a network side knows the best downlink beam. Therefore, the SSB needs to have an association with the preambles, and the preambles can only be sent in a Physical Random Access Channel (PRACH) transmission occasion. In this case, the SSB is associated with the PRACH transmission occasion.

### Beam Establishment

A process in which the downlink beam is selected and determined includes the following step P1 to step P3 (sending by the base station and receiving by the UE).

Step P1: A transmit antenna (Tx) performs beam scanning by sending an SSB signal (one SSB corresponds to one transmit beam (Tx beam)). Beams on both a base station side and a UE side are traversing. The UE side needs to automatically find a suitable receiving beam (Rx beam) for each SSB signal (because the SSB is used as a top layer of a QCL, it needs to be ensured that each SSB corresponds to a suitable receiving beam).

Step P2: The transmit antenna performs beam refinement scanning by sending a CSI-RS (periodicity, semi-persistent, or non-periodicity) or SSB (only periodicity) signal in a transmit wide beam (Tx wide beam) range determined after step P1 ends. The receiving beam remains unchanged, and determines a transmit narrow beam (Tx narrow beam).

Step P3: A transmit beam is fixed as the transmit narrow beam selected after step P2 ends, and sends the CSI-RS (repetition= “on”, that is, a QCL relationship is not configured, and the UE autonomously performs receiving and scanning) signal. A receiving antenna performs beam scanning, and determines the receiving beam.

### Preamble

After a cell searches the process and obtains system information, the UE obtains downlink synchronization with the cell. In this case, the UE can receive downlink data. However, the UE can perform uplink transmission only if obtaining uplink synchronization with the cell. The UE establishes a connection to the cell through a random access procedure, and obtains uplink synchronization with the cell. After the random access procedure succeeds, the UE is in a Radio Resource Control (RRC) connected state, and may perform normal uplink and downlink transmission with a network. A main purpose of random access is: (1) obtaining uplink synchronization; and (2) allocating a unique Cell-Radio Network Temporary Identifier (C-RNTI) to the UE.

Step 1 of the random access procedure is that the UE sends a random access preamble. A main function of the preamble is to notify a 5G base station (g-node-B (gNB)) that there is a random access request, and enable the gNB to estimate a transmission delay between the 5G base station and the UE, so that the gNB calibrates uplink timing and notifies the UE of calibration information through a timing advance command in a Random Access Response (RAR).

Cyclic shifting is performed on a root Zadoff-Chu sequence to generate a preamble sequence. 64 preambles are defined on each PRACH time-frequency occasion. The 64 preambles are numbered first in ascending order of a cyclic shift N_cs of a logical root sequence, and then are numbered in the ascending order of different logical root sequences. If the 64 preambles cannot be obtained through cyclic shifting based on a single root sequence, remaining preamble sequences are generated through root sequences corresponding to following indexes until the 64 preambles are all generated.

### Mapping of the Preamble to the SSB

The beam is used in the NR random access procedure. The SSB has the plurality of sending opportunities in the time domain periodicity, and has corresponding numbers, where the numbers can correspond to different beams respectively. However, for the UE, only when the beam scan signal of the SSB covers the UE, the UE has the opportunity to send the preamble. When receiving the preambles of the UE, the network side knows the best downlink beam. Therefore, the SSB needs to have the association with the preamble, and the preamble can only be sent in the PRACH transmission occasion. In this case, the SSB is associated with the PRACH transmission occasion.

A higher layer configures, through parameters, that is, an SSB number associated with each PRACH transmission occasion and a contention-based preamble number and associated with each SSB, an SSB number N (SSB-perRACH-Occasion) associated with each PRACH transmission occasion and a contention-based preamble number R (CB-PreamblesPerSSB) and associated with each SSB. A contention-based preamble number on one PRACH transmission occasion is R*max (1, N).

There are the following two configurations for N.

(a) When N<1, one SSB is mapped to 1/N consecutive valid PRACH transmission occasions (frequency domain). For example, when N=1/4, one SSB is mapped to four PRACH transmission occasions, as shown in FIG. 2, R consecutive indexed preambles are mapped to SSB n, and each valid PRACH transmission occasion starts from a preamble index 0. For example, when R=4, on each PRACH transmission occasion, four contention-based preamble indexes corresponding to Synchronization Signal/Physical broadcast channel block (SS/PBCH block) associated with the PRACH transmission occasion are {0, 1, 2, 3}. FDM=4 indicates that there are four PRACH transmission occasions on the PRACH transmission occasion in one time domain. Each box in the figure is an independent Random Access Channel (RACH) transmission occasion, and each RACH transmission occasion is identified through a subscript in the time domain and a subscript in the frequency domain.

When N=1/2 and FDM=4, for a specific resource configuration, refer to FIG. 3.

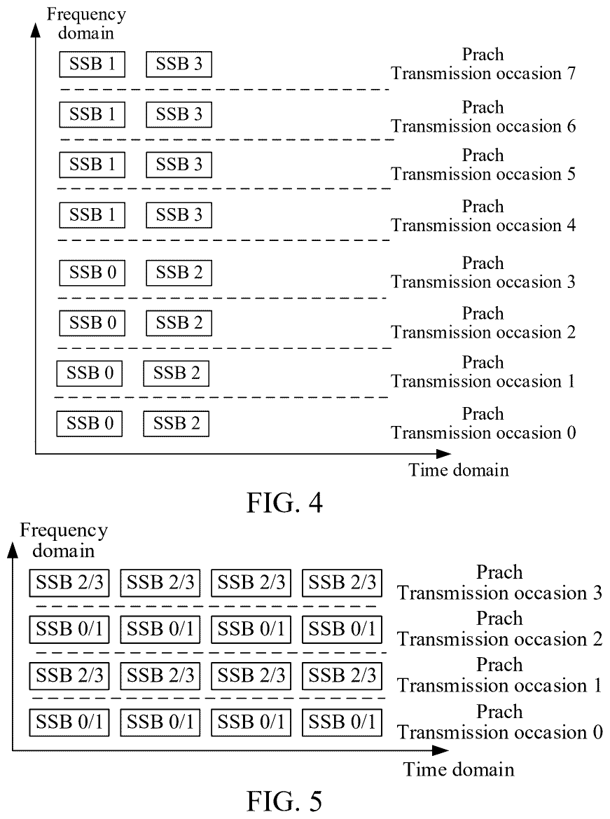

When N=1/4 and FDM=8, for a specific resource configuration, refer to FIG. 4.

(b) When N>1, N SSBs are mapped to one valid PRACH transmission occasion. For example, when N=2, two SSBs are mapped to one PRACH transmission occasion. When OSN≤N-1, each valid PRACH transmission occasion starts from a preamble index N*N_preamble∧total/N. For example, as shown in FIG. 5, when N=2 and N_preamble∧total/N=64, one PRACH transmission occasion is mapped to two SSBs, and SSB n=0, 1. When n=0, a preamble index of an SSB 0 starts from 0. When n=1, a preamble index of an SSB 1 starts from 32. N_preamble∧total is configured through total Number Of RA-Preambles, and needs to be an integer multiple of N. The total Number Of RA-Preambles defines a total number of preambles for contention and non-contention random access on one PRACH resource, but does not include preambles for other purposes, for example, a preamble for a System Information (SI) request. Therefore, it may be understood herein that, the preambles on one PRACH transmission occasion are evenly divided into N parts, and first R consecutive indexed preambles of each part are used for contention-based random access, and are associated with a specific SS/PBCH block. In this case, the contention-based preamble number on one PRACH transmission occasion is R*N.

### Downlink Wake-Up Signal (DL WUS)

In a 5G system, to further improve power saving performance of the UE, a wake-up signal based on a Physical downlink control channel (PDCCH) is introduced. The wake-up signal is used to inform the UE whether the PDCCH needs to be monitored during a specific on duration of Discontinuous Reception (DRX). When there is no data, the UE may not need to monitor the PDCCH during the on duration, which is equivalent to that the UE may be in a sleep state in an entire DRX long periodicity. Therefore, power is further saved.

The wake-up signal is Downlink Control Information (DCI), which is referred to as DCP (DCI with CRC scrambled by PS-RNTI) for short. For example, the PS-RNTI is an RNTI allocated by the network to the UE for a power saving characteristic. The DCI scrambled by the RNTI carries a wake-up/sleep indication of the network for the UE. The UE determines, based on the indication, whether to start an on duration timer in a next DRX periodicity and whether to perform PDCCH monitoring.

It is worth noting that, the technologies described in embodiments of this application are not limited to a Long Term Evolution (LTE)/LTE-Advanced (LTE-A) system, and may be further applied to other wireless communication systems, for example, a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and other systems. The terms “system” and “network” in embodiments of this application may usually be used interchangeably. The technology described in embodiments of this application can be applied to the systems and radio technologies mentioned above, and can also be applied to other systems and radio technologies. The following describes a New Radio (NR) system for example, and NR terms are used in most of the following descriptions. However, these technologies may alternatively be applied to an application in a system other than the NR system, for example, a 6th Generation (6G) system.

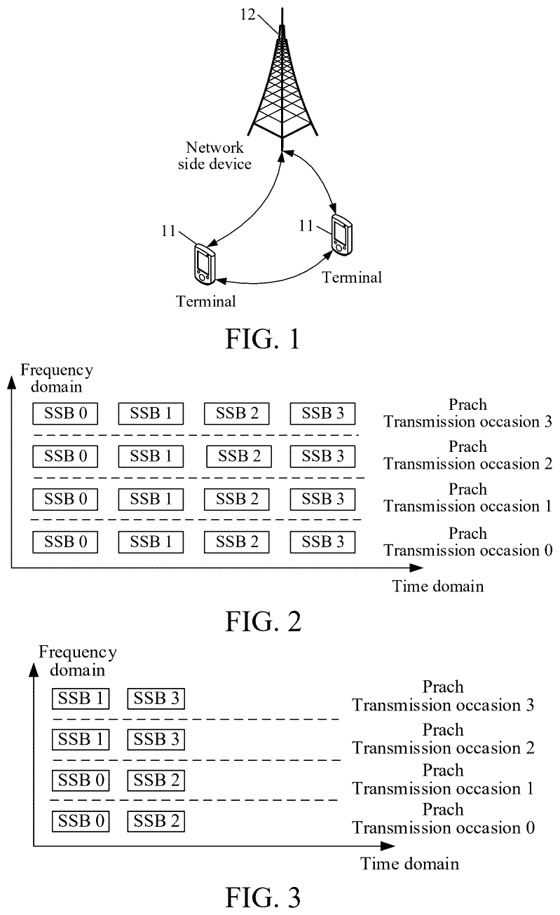

FIG. 1 is a block diagram of a wireless communication system to which an embodiment of this application is applicable. The wireless communication system includes a terminal 11 and a network side device 12. The terminal 11 may be a mobile phone, a tablet computer, a laptop computer or notebook computer, a Personal Digital Assistant (PDA), a palmtop computer, a netbook, an Ultra-mobile Personal Computer (UMPC), a Mobile Internet Device (MID), an Augmented Reality (R) device/a Virtual Reality (VR) device, a robot, a wearable device, a Vehicle-mounted Device (VUE), a Pedestrian Terminal (PUE), a smart home (a home appliance having a wireless communication function, for example, a refrigerator, a television, a washing machine, or furniture), a game console, a Personal Computer (PC), a terminal side device such as a teller machines or a self-service machine. The wearable device includes a smart watch, a smart bracelet, a smart headphone, smart glasses, smart jewelry (a smart ring, a smart necklace, and a smart anklet), a smart wristband, smart clothes, and the like. It should be noted that the specific type of the terminal 11 is not limited embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a basic service set (Basic Service Set, BSS), an Extended Service Set (ESS), a home NodeB, a home evolved NodeB, a Transmitting Receiving Point (TRP), or other proper terms in the field. The base station is not limited to a specific technical term, provided that the same technical effect is achieved. It should be noted that, as an example, and a specific type of the base station is not limited. It should be noted that, in embodiments of this application, only the base station in the NR system is taken as an example for introduction, and a specific type of the base station is not limited.

With reference to the accompanying drawings, the following provides detailed descriptions of a beam selection method provided in embodiments of this application by using some embodiments and application scenarios.

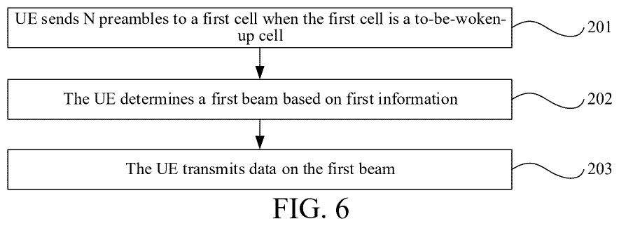

FIG. 6 is a schematic flowchart of a beam selection method according to an embodiment of this application. As shown in FIG. 6, the beam selection method may include the following step 201 to step 203.

Step 201: UE sends N preamble(s) to a first cell when the first cell is a to-be-woken-up cell.

In this embodiment of this application, the first cell is different from a serving cell of the UE.

Step 202: The UE determines a first beam based on first information.

In this embodiment of this application, the first information is related to the N preamble(s) sent by the UE.

In this embodiment of this application, the first information may be configured through radio resource control or a system message, or may be configured in a corresponding indication field in a downlink signal.

In this embodiment of this application, a base station in an energy saving state in the to-be-woken-up cell transmits the first information to the serving cell. For example, the foregoing transmission process is implemented through a higher-layer interface, for example, an Xn interface.

In this embodiment of this application, the first information includes at least one of the following:
a first SSB;
a first preamble;
timing calibration information; and
a cell identifier of the first cell.

In this embodiment of this application, the first preamble is a preamble in the N preamble(s) that corresponds to the first SSB, and the timing calibration information is configured for calibrating time information of a first network side device corresponding to the first cell.

In this embodiment of this application, the first network side device is in an energy saving mode. In other words, when the UE wakes up the first network side device in the energy saving mode, the first cell of the first network side device may be considered as the to-be-woken-up cell.

Step 203: The UE transmits data on the first beam.

In this embodiment of this application, the first beam is configured to send and receive data of the first cell.

In this embodiment of this application, that the UE transmits data on the first beam includes at least one of the following:
monitoring a first PDCCH corresponding to the first beam;
measuring a first SSB or a first RS corresponding to the first beam; and
sending a RACH or a PUCCH on a time-frequency resource corresponding to the first beam.

For example, the first PDCCH includes a PDCCH for scheduling system information corresponding to the first SSB.

In embodiments of this application, the UE sends the N preamble(s) to the first cell when the first cell is the to-be-woken-up cell, where the first cell is different from the serving cell of the UE; the UE determines the first beam based on the first information, where the first information is related to the N preamble(s); and the UE transmits data on the first beam. In this way, the UE may send the N preamble(s) to the to-be-woken-up first cell, to obtain the first information and determine the first beam, and then may transmit the data on the first beam, to enable the UE to quickly and establish a beam connection to the to-be-woken-up first cell.

For example, in this embodiment of this application, before step 201 “UE sends N preamble(s) to the first cell”, the beam selection method provided in this embodiment of this application further includes the following step 301 and step 302.

Step 301: The UE obtains second information.

Step 302: The UE sends the N preamble(s) to the first cell based on the second information.

For example, the second information is configured through the first cell.

For example, the second information may be configured in the RRC or the system message, or may be in the indication field of the downlink signal, or may be configured in a separate indication field (in the RRC), or may be configured by adding a related indication field to an existing indication field.

For example, the second information includes at least one of the following:
an SSB configuration of the first cell;
a mapping relationship between an SSB of the first cell and the N preamble(s);
a PRACH transmission occasion; and
a time-frequency resource of the N preamble(s).

It may be understood that, the second information may include pre-configuration information of the first cell. The pre-configuration information of the first cell includes at least one of the following: the SSB configuration, a mapping relationship between an SSB and preambles, a PRACH transmission occasion, and the like.

For example, in this embodiment of this application, when the second information directly includes a time-frequency resource of to-be-sent N preamble(s), the UE may directly send the N preamble(s) to the first cell based on the time-frequency resource of the N preamble(s).

For example, in this embodiment of this application, when the second information includes at least one of the following: the SSB configuration of the first cell, the mapping relationship between the SSB of the first cell and the N preamble(s), and the PRACH transmission occasion, the UE may indirectly determine the time-frequency resource of the to-be-sent N preamble(s) based on the information, and then may send the N preamble(s) to the first cell based on the time-frequency resource.

For example, step 302 “The UE sends the N preamble(s) to the first cell based on the second information” may include the following step 302a and step 302b.

Step 302a: The UE determines the time-frequency resource of the N preamble(s) based on the second information.

Step 302b: The UE sends the N preamble(s) to the first cell based on the determined time-frequency resource of the N preamble(s).

Further, for example, in this embodiment of this application, step 302a “The UE determines the time-frequency resource of the N preamble(s) based on the second information” may include the following step 302al and step 302a2.

Step 302al: The UE determines the time-frequency resource of the N preamble(s) based on the second information and according to a first rule.

For example, the first rule includes at least one of the following:
Rule 1: A quantity of to-be-sent preambles is determined based on a quantity of SSBs corresponding to the first cell; and
Rule 2: A position of a time-frequency resource of a to-be-sent preamble is determined based on the following content:

the quantity of SSBs corresponding to the first cell;
a PRACH transmission occasion;
a RACH transmission occasion of each SSB corresponding to the first cell; and
msg1-FDM.

For example, the quantity of to-be-sent preambles may be equal to the quantity of SSBs corresponding to the first cell, or may be a multiple of the quantity of SSBs corresponding to the first cell.

For example, the UE may send the N preamble(s) to the first cell in at least one of the following sending manners.

### Manner 1: TDM Manner

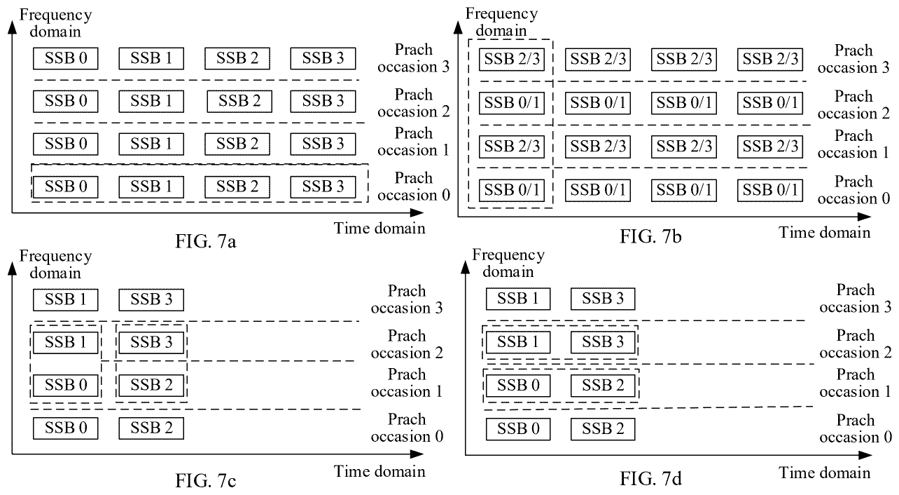

For example, as shown in FIG. 7a, preambles may be sent in a time domain order. For example, a plurality of preambles are sequentially sent from a moment TO to a moment T3. For example, referring to FIG. 7a, it is assumed that the base station receives the strongest preamble sequence at a moment T1, or the base station determines that the preamble received at this moment is the best. In this case, the base station may select an SSB 1 as a downlink beam.

It should be noted that, each block in FIG. 7a-FIG. 7d corresponds to a time-frequency position, and an SSB number in each time-frequency position represents a downlink SSB beam sent by the corresponding base station at the time-frequency position.

### Manner 2: FDM Manner

For example, as shown in FIG. 7b, preambles may be sent in a frequency domain order. For example, in four frequency domains from bottom to top of SSB 0/1 to SSB 2/3 in a dashed box, downlink SSB beams of the corresponding base station are sequentially sent at corresponding time-frequency positions.

For example, referring to FIG. 7b, it is assumed that the base station receives the strongest preamble sequence in a frequency domain F3, or the base station determines that the preamble received in the frequency domain F3 is the best. In this case, the base station selects the SSB 0 or the SSB 1 as the downlink beam. Further, for example, a beam that is selected is determined based on the preamble sequence (for example, preambles 0 to 31 represent the SSB 0, and preambles 32 to 63 represent the SSB 1).

### Manner 3: Manner of FDM Before TDM

For example, as shown in FIG. 7c, preambles may be sent first in the frequency domain order and then in the time domain order. For example, in SSB 0 to SSB 3 in the dashed box first from bottom to top and then from left to right, downlink SSB beams of the corresponding base station are sent at corresponding time-frequency positions.

### Manner 4: Manner of TDM Before FDM

For example, as shown in FIG. 7d, preambles may be sent first in the time domain order and then in the frequency domain order. For example, in SSB 0 to SSB 3 in the dashed box first from left to right and then from bottom to top, downlink SSB beams of the corresponding base station are sent at corresponding time-frequency positions.

For example, in this embodiment of this application, step 301 “The UE obtains second information” may include the following step 301a.

Step 301a: The UE obtains the second information sent by the first network side device.

For example, the first network side device is in the energy saving mode.

For example, the first network side device may be the base station in the energy saving state corresponding to the to-be-woken-up first cell.

For example, the second information is sent by the first network side device to a second network side device corresponding to the serving cell of the UE, and then is sent by the second network side device to the UE.

For example, in this embodiment of this application, after receiving the N preamble(s), the first network side device may determine the first beam based on the N preamble(s), and then the first information that indicates the first beam is sent to the UE through the second network side device, so that the UE can directly determine the first beam based on the first information.

For example, in this embodiment of this application, the UE determines the first beam according to a specific rule.

For example, before step 202 “The UE determines a first beam based on first information”, the beam selection method provided in this embodiment of this application further includes the following step 401.

Step 401: The UE detects a downlink signal after sending each of the preambles.

For example, the UE detects the downlink signal in a first pre-determined time after sending the preamble each time.

For example, the first pre-determined time is configured for the UE by the serving cell through the RRC, the system message, or the related indication field of the downlink signal.

Step 402: The UE determines the first beam based on signal quality of the detected downlink signal.

For example, the first information includes the signal quality of the downlink signal. In other words, the UE detects the downlink signal in a pre-determined time period after sending the preamble, to determine the first beam.

For example, the signal quality of the downlink signal includes at least one of the following: Reference Signal Received Power (RSRP), a Signal-to-Interference Plus Noise Ratio (SINR), a Signal-to-Noise Ratio (SNR), and the like.

In a possible example, the UE may select a receiving beam with the best signal quality from the detected downlink signal as the first beam.

In another possible example, the UE may select one beam by comprehensively considering a beam corresponding to the best current signal quality and historical information of previously used beams. For example, a beam 1 is previously used, and a plurality of beams currently received by the UE are the beam 1, a beam 2, and a beam 3 respectively. Signal quality of the plurality of beams is the beam 2>the beam 1>the beam 3. In this case, the UE selects the beam 1 as the receiving beam.

For example, in this embodiment of this application, in the process of step 401, that is, in the process in which the UE detects the downlink signal, the beam selection method provided in this embodiment of this application further includes the following step A1.

Step A1: The UE re-sends the N preamble(s) when a first condition is met.

For example, the first condition includes any one of the following:
Condition 1: The UE fails to detect the downlink signal in the first pre-determined time after sending the preamble; and
Condition 2: The signal quality of the downlink signal detected by the UE does not meet a pre-determined condition.

For example, the first pre-determined time is configured for the UE by the serving cell through the RRC, the system message, or the related indication field of the downlink signal.

For example, the foregoing pre-determined condition is that the RSRP/SINR/SNR of the detected downlink signal is lower than a pre-determined threshold.

For example, the foregoing pre-determined threshold is pre-configured in a protocol.

For example, in this embodiment of this application, in the process of step A1, the beam selection method provided in this embodiment of this application further includes the following step B1.

Step B1: The UE stops sending the N preamble(s) if the UE repeatedly sends the N preamble(s) a plurality of times and fails to detect the downlink signal each time.

For example, a quantity of the plurality times of repeated sending is pre-configured in a protocol.

In this way, the UE may select the beam with the best signal quality detected by the UE as the first beam, and transmit data on the beam.

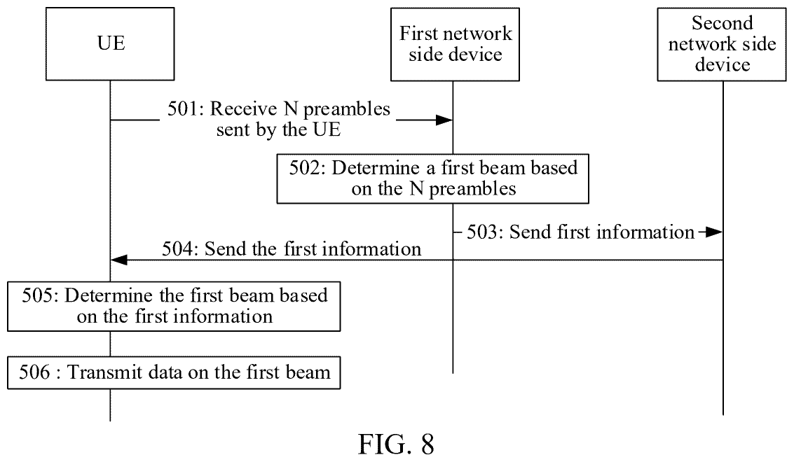

FIG. 8 is a schematic flowchart of a beam selection method according to an embodiment of this application. As shown in FIG. 8, the beam selection method may include the following step 501 to step 503.

Step 501: A first network side device receives N preamble(s) sent by UE.

Step 502: The first network side device determines a first beam based on the N preamble(s).

Step 503: The first network side device sends first information to a second network side device.

Step 504: The second network side device sends the first information to the UE.

Step 505: The UE determines the first beam based on the first information.

Step 506: The UE transmits data on the first beam.

In this embodiment of this application, the first information is configured for indicating the first beam, and the first network side device is in an energy saving mode.

In this embodiment of this application, the first network side device is a base station in an energy saving state.

In this embodiment of this application, a cell corresponding to the second network side device includes a serving cell of the UE. In other words, the second network side device is a base station corresponding to the serving cell of the UE.

It should be noted that, for detailed descriptions of the first information, refer to the related descriptions of the first information in the embodiment shown in FIG. 6. Details are not described herein again.

For example, in this embodiment of this application, in the process of step 502, the beam selection method provided in this embodiment of this application may include the following step 502a.

Step 502a: The first network side device determines the first beam based on channel quality of a transmission channel of the N preamble(s).

In a possible example, the first network side device receives the N preamble(s) at a corresponding position, and selects one preamble with the best channel quality, that is, selects one preamble with RSRP/SINR higher than a pre-determined threshold.

In another possible example, the first network side device may select one preamble by comprehensively considering the preamble with the best current channel quality and historical information of previously received and used preambles, and determine the first beam based on the preamble. For example, a preamble 1 is previously used, and a plurality of channels currently received by the UE correspond to preambles, that is, a channel 1, a channel 2, and a channel 3 respectively. Signal quality of the channels is the channel 2>the channel 1>the channel 3. In this case, the UE selects the preamble corresponding to the channel 1, and uses the beam corresponding to the preamble as the receiving beam.

For example, in this embodiment of this application, before step 501, the beam selection method provided in this embodiment of this application further includes the following step C1.

Step C1: The first network side device configures second information for the UE.

For example, the second information includes at least one of the following:
an SSB configuration of the first cell;
a mapping relationship between an SSB of the first cell and the N preamble(s);
a PRACH transmission occasion; and
a time-frequency resource of the N preamble(s).

For example, the first network side device configures the second information for the UE through the RRC or the downlink signal.

For example, the downlink signal includes the SSB, a System Information Block (SIB) 1, a PDCCH, a Physical Downlink Shared Channel (PDSCH), a CSI-RS, and the like.

For example, in this embodiment of this application, before step 503, the beam selection method provided in this embodiment of this application further includes the following step D1.

Step D1: The first network side device receives a wake-up signal sent by the UE on a time-frequency resource corresponding to the first beam.

For example, the wake-up signal includes at least one of the following:
a preamble of the first beam; and
a PUCCH of the first beam.

In this embodiment of this application, the first network side device receives the N preamble(s) sent by the UE. Therefore, the first network side device determines the first beam based on the N preamble(s) sent by the UE. Then, the first network side device sends the first information that indicates the first beam to the second network side device. The first network side device is in the energy saving mode. The cell corresponding to the second network side device includes the serving cell of the UE. In this way, the first network side device receives the N preamble(s) sent by the UE, to determine the first beam and send the first information that indicates the first beam to the second network side device, so that the network side device can transmit the data on the first beam, to enable the UE to quickly and establish a beam connection to the to-be-woken-up first cell.

The technical solutions provided in embodiments of this application are exemplarily described below by using two embodiments.

### Embodiment 1

This embodiment mainly considers a case in which the wake-up signal sent by the UE to the first network side device is a preamble.

A premise of this embodiment is that the UE is located in the serving cell and is in a connected state. One neighboring cell is in the energy saving mode. In other words, the cell may not send the downlink signal, but may receive some uplink signals.

For example, for a scenario in which the first information indicates the first beam, the beam selection method provided in this embodiment of this application includes the following step S1 to step S6.

Step S1: The serving cell (that is, the second network side device) configures a quantity of SSBs, a mapping relationship between the SSB and preambles, a PRACH transmission occasion, and the like of the base station (that is, the first network side device) in the energy saving mode for the UE through RRC or a downlink signal. The downlink signal includes an SSB, a SIB 1, a PDCCH, a PDSCH, a CSI-RS, and the like.

For example, if the mapping relationship between the SSB and the preambles of the base station in the energy saving mode is consistent with, that is, completely the same as that of a current serving cell, the serving cell does not need to additionally configure the mapping relationship between the SSB and the preambles, the PRACH transmission occasion, and the like of the energy saving base station (that is, the first network side device), and only needs to configure the consistency information for the UE through the RRC or the downlink signal.

Step S2: The UE sends the N preamble(s) at a corresponding position based on the configured information of the base station in the energy saving mode and according to the first rule. The first rule is as follows.

Rule 1: A quantity of to-be-sent preambles is determined based on a quantity of SSBs of the base station in the energy saving state. The quantity of to-be-sent preambles may be equal to or may be a multiple of the quantity of SSBs.

Rule 2: Time-frequency positions of the to-be-sent preambles are determined based on the quantity of SSBs, the PRACH transmission occasion, the RACH transmission occasion of each SSB corresponding to the first cell, and msg1-FDM jointly.

The UE may send the N preamble(s) to the first cell in at least one of the following sending manners:
Manner 1: TDM manner;
Manner 2: FDM manner;
Manner 3: Manner of FDM before TDM; and
Manner 4: Manner of TDM before FDM.

For details, refer to FIG. 7a-FIG. 7d.

Step S3: The base station in the energy saving state receives the N preamble(s) at a corresponding position, and selects a preamble with the best channel quality. In other words, a preamble with RSRP/SINR higher than a specific threshold is selected.

In some embodiments, the base station in the energy saving state selects one preamble by comprehensively considering N currently received preambles and historical information of previously received and used preambles.

Step S4: The base station in the energy saving state synchronizes the selected preamble and/or the SSB (that is, the downlink beam) corresponding to the preamble and information such as timing calibration to the serving cell.

Step S5: The serving cell configures information about the beam and the information such as timing calibration for the UE. A manner of the configuring may be configuring through the RRC or configuring in a corresponding indication field in the downlink signal.

Step S6: After determining the uplink/downlink beam, the UE transmits data in the beam.

### Embodiment 2

For example, for a scenario in which the first information is a downlink signal, that is, when the UE determines the first beam, the beam selection method provided in this embodiment of this application includes the following step S1 to step S7.

Step S1: The serving cell (that is, the second network side device) configures a quantity of SSBs, a mapping relationship between the SSB and preambles, a PRACH transmission occasion, and the like of the base station (that is, the first network side device) in the energy saving mode for the UE through RRC or a downlink signal. The downlink signal includes an SSB, a SIB 1, a PDCCH, a PDSCH, a CSI-RS, and the like.

For example, if the mapping relationship between the SSB and the preambles of the base station in the energy saving mode is consistent with, that is, completely the same as that of a current serving cell, the serving cell does not need to additionally configure the mapping relationship between the SSB and the preambles, the PRACH transmission occasion, and the like of the energy saving base station (that is, the first network side device), and only needs to configure the consistency information for the UE through the RRC or the downlink signal.

Step S2: The UE sends the N preamble(s) at a corresponding position based on the configured information of the base station in the energy saving mode and according to the first rule.

It should be noted that, for related descriptions of the first rule and the sending manner, refer to the description content in Embodiment 1. Details are not described herein again.

Step S3: The base station in the energy saving state receives the N preamble(s) at the corresponding position, and selects a preamble with the best channel quality. In other words, a preamble with RSRP/SINR higher than a specific threshold is selected.

Step S4: After determining a downlink beam, the base station (that is, the first network side device) in the energy saving state sends the beam in a repetition (repetition) manner in a specific time.

Step S5: The UE detects the downlink signal in a first pre-determined time after sending the preamble, and determines the first beam based on the detected downlink signal. For example, a receiving beam (Rx beam) with the best downlink signal quality is the first beam. The first pre-determined time is configured for the UE by the serving cell through the RRC or a related indication field of the downlink signal.

In some embodiments, the UE selects one beam by comprehensively considering the beam corresponding to the best current signal quality and historical information of the previously used beams.

Step S6: After determining the uplink/downlink beam, the UE transmits data in the beam.

Step S7: If the UE fails to detect the downlink signal in the first pre-determined time after sending the preamble, or the signal quality (for example, RSRP/SINR/SNR) of the detected downlink signal is lower than the specific threshold, the UE re-sends the N preamble(s). If the downlink signal fails to be detected after a plurality of times of sending, the UE stops sending.

In this way, before the base station in the energy saving state is woken up, the first beam is quickly determined through the N preamble(s), so that the UE can quickly establish a beam connection to the to-be-woken-up first cell.

Embodiments of this application provide a beam selection method, and an execution entity may be a beam selection apparatus. In embodiments of this application, that the beam selection apparatus performs the beam selection method is used as an example to explain the beam selection apparatus provided by embodiments of this application.

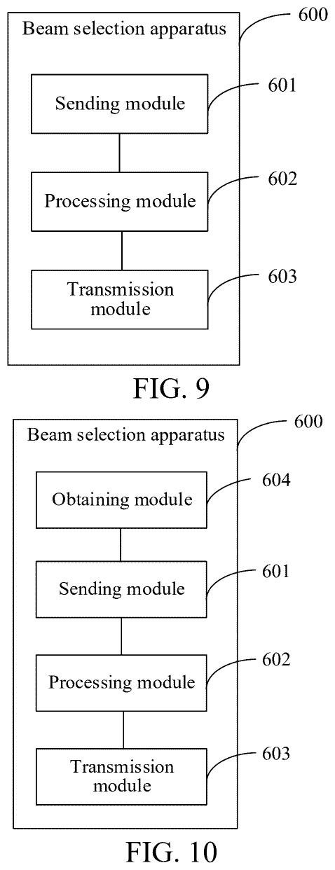

Embodiments of this application provide a beam selection apparatus. As shown in FIG. 9, a beam selection apparatus 600 includes a sending module 601, a processing module 602, and a transmission module 603. The sending module 601 is configured to send N preamble(s) to a first cell when the first cell is a to-be-woken-up cell, where the first cell is different from a serving cell of UE. The processing module 602 is configured to determine a first beam based on first information, where the first information is related to the N sent preambles. The transmission module 603 is configured to transmit data on the first beam.

For example, in this embodiment of this application, the first information includes at least one of the following: a first SSB; a first preamble; timing calibration information; and a cell identifier of the first cell; where the first preamble is a preamble that corresponds to the first SSB in the N preamble(s), the timing calibration information is configured for calibrating time information of a first network side device corresponding to the first cell, and the first network side device is in an energy saving mode.

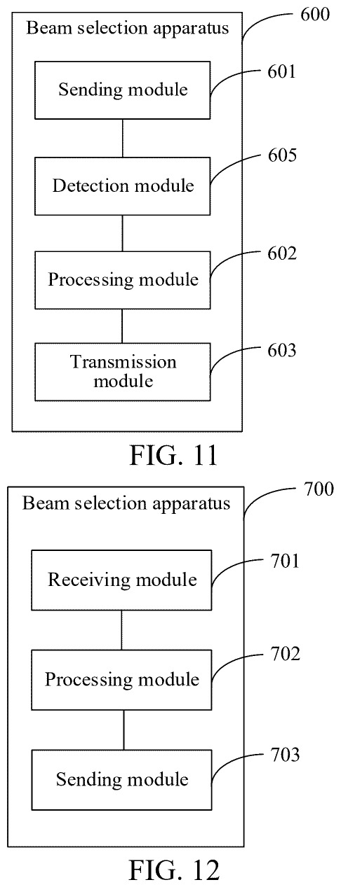

For example, in this embodiment of this application, with reference to FIG. 9, as shown in FIG. 10, the beam selection apparatus 600 further includes an obtaining module 604. The obtaining module 604 is configured to obtain second information. In some embodiments, the sending module 601 is configured to send the N preamble(s) to the first cell based on the second information. The second information is configured through the first cell.

For example, in this embodiment of this application, the second information includes at least one of the following: an SSB configuration of the first cell; a mapping relationship between an SSB of the first cell and the N preamble(s); a PRACH transmission occasion; and a time-frequency resource of the N preamble(s).

For example, in this embodiment of this application, the processing module 602 is further configured to determine a time-frequency resource of the N preamble(s) based on the second information. In some embodiments, the sending module 601 is configured to send the N preamble(s) to the first cell based on the determined time-frequency resource of the N preamble(s).

For example, in this embodiment of this application, the processing module 602 is configured to determine a time-frequency resource of the N preamble(s) based on the second information and according to a first rule. The first rule includes at least one of the following: a quantity of to-be-sent preambles is determined based on a quantity of SSBs corresponding to the first cell; and a position of a time-frequency resource of a to-be-sent preamble is determined based on the following content: the quantity of SSBs corresponding to the first cell, a PRACH transmission occasion, a RACH transmission occasion of each SSB corresponding to the first cell, and msg1-FDM.

For example, in this embodiment of this application, the obtaining module 604 is configured to obtain the second information sent by a first network side device, where the first network side device is in an energy saving mode.

For example, in this embodiment of this application, as shown in FIG. 11 with reference to FIG. 9, the beam selection apparatus 7 further includes a detection module 605. The detection module 605 is configured to detect a downlink signal after sending each of the preambles. In some embodiments, the processing module 602 is configured to determine the first beam based on signal quality of the detected downlink signal, where the first information includes the signal quality of the downlink signal.

For example, in this embodiment of this application, the sending module 601 is further configured to re-send the N preamble(s) when a first condition is met, where the first condition includes any one of the following: the UE fails to detect the downlink signal in a first pre-determined time after sending the preamble; and the signal quality of the downlink signal detected by the UE does not meet a pre-determined condition.

For example, in this embodiment of this application, the sending module 601 is further configured to stop sending the N preamble(s) if the N preamble(s) are repeatedly sent a plurality of times and the downlink signal fails to be detected each time.

For example, in this embodiment of this application, that the UE transmits data on the first beam includes at least one of the following:
monitoring a first PDCCH corresponding to the first beam;
measuring a first SSB or a first RS corresponding to the first beam; and
sending a RACH or a PUCCH on a time-frequency resource corresponding to the first beam.

For example, in this embodiment of this application, the first PDCCH includes a PDCCH for scheduling system information corresponding to the first SSB.

In the beam selection apparatus provided in this embodiment of this application, the apparatus sends the N preamble(s) to the first cell when the first cell is the to-be-woken-up cell, where the first cell is different from the serving cell of the UE; determines the first beam based on the first information, where the first information is related to the N preamble(s); and transmits the data on the first beam. In this way, the UE may send the N preamble(s) to the to-be-woken-up first cell, to obtain the first information and determine the first beam, and then may transmit the data on the first beam, to enable the UE to quickly and establish a beam connection to the to-be-woken-up first cell.

Embodiments of this application provide a beam selection apparatus. As shown in FIG. 12, the beam selection apparatus 700 includes a receiving module 701, a processing module 702, and a sending module 703. The receiving module 701 is configured to receive N preamble(s) sent by UE. The processing module 702 is configured to determine a first beam based on the N received preambles. The sending module 703 is configured to send first information to a second network side device; where the first information is configured for indicating the first beam, the first network side device is in an energy saving mode, and a cell corresponding to the second network side device includes a serving cell of the UE.

For example, in this embodiment of this application, the processing module 702 is configured to determine the first beam based on channel quality of a transmission channel of the N preamble(s).

For example, in this embodiment of this application, the first information includes at least one of the following: a first SSB; a first preamble; timing calibration information; a cell identifier of the first cell; where the first cell is a cell to be woken up by the UE in a cell corresponding to the first network side device; the first preamble is a preamble in the N preamble(s) that corresponds to the first SSB; and the timing calibration information is configured for calibrating time information of the first network side device corresponding to the first cell.

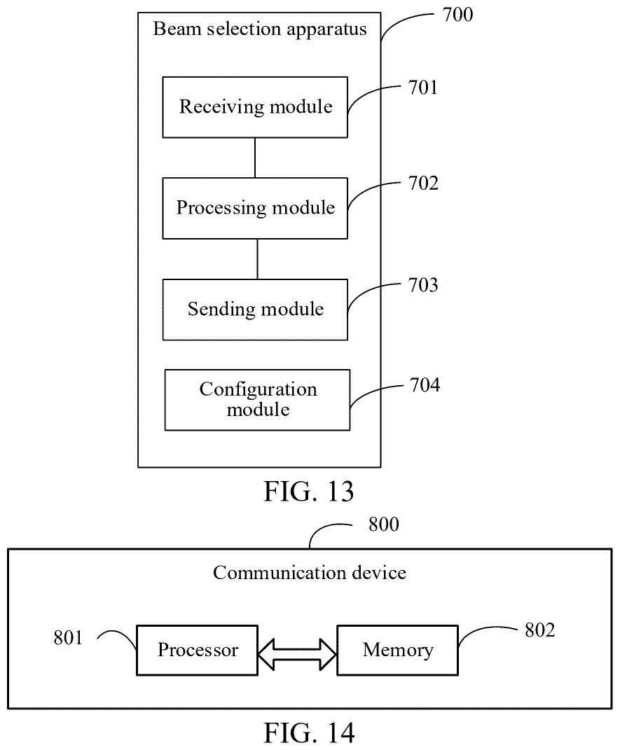

For example, in this embodiment of this application, with reference to FIG. 12, as shown in FIG. 13, the beam selection apparatus 700 further includes a configuration module 704. The configuration module 704 is configured to configure second information for the UE, where the second information includes at least one of the following: an SSB configuration of the first cell; a mapping relationship between an SSB of the first cell and the N preamble(s); a PRACH transmission occasion; and a time-frequency resource of the N preamble(s).

For example, in this embodiment of this application, the receiving module 701 is further configured to receive a wake-up signal sent by the UE on a time-frequency resource corresponding to the first beam, where the wake-up signal includes at least one of the following: a preamble of the first beam; and a PUCCH of the first beam.

In the beam selection apparatus provided in this embodiment of this application, the apparatus receives the N preamble(s) sent by the UE. Therefore, the first beam is determined based on the N preamble(s) sent by the UE, and the first information that indicates a first beam is sent to the second network side device. The first network side device is in an energy saving mode. The cell corresponding to the second network side device includes the serving cell of the UE. In this way, the first network side device receives the N preamble(s) sent by the UE, to determine the first beam and send the first information that indicates the first beam to the second network side device, so that the network side device can transmit the data on the first beam, to enable the UE to quickly and establish a beam connection to the to-be-woken-up first cell.

The beam selection apparatus in this embodiment of this application may be an electronic device, for example, an electronic device with an operating system, or may be a component in an electronic device, for example, an integrated circuit or a chip. The electronic device may be the terminal, or may be a device other than the terminal. For example, the terminal may include but not limited to a type of the terminal 11 listed above. Other devices may be a server, a Network Attached Storage (NAS) and the like. Embodiments of this application are not specifically limited.

The beam selection apparatus provided in this embodiment of this application can implement the processes implemented in method embodiments shown in FIG. 9 to FIG. 13, and achieve a same technical effect. To avoid repetition, details are not described herein again.

For example, as shown in FIG. 14, embodiments of this application further provide a communication device 800, including a processor 801 and a memory 802. The memory 802 stores a program or an instruction run on the processor 801. For example, when the communication 800 is a terminal, each step of method embodiments for implementing the beam selection method is implemented when the program or the instruction is executed by the processor 801, and a same technical effect can be achieved. When the communication device 800 is a network side device, each step of the beam selection method is implemented when the program or the instruction is executed by the processor 801, and the same technical effect can be achieved. To avoid repetition, this is not described herein again.

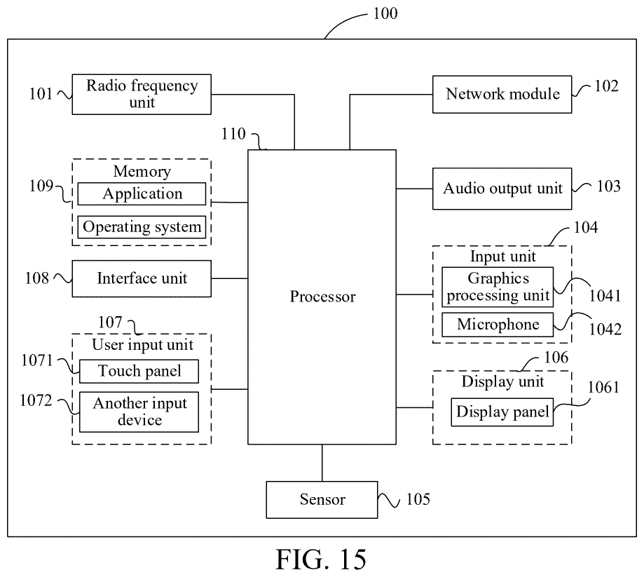

Embodiments of this application further provide a terminal, including a processor and a communication interface. The communication interface is configured to send N preamble(s) to a first cell when the first cell is a to-be-woken-up cell, where the first cell is different from a serving cell of UE. The processor is configured to determine a first beam based on first information, where the first information is related to the N preamble(s). The UE transmits data on the first beam. This terminal embodiment corresponds to foregoing terminal side method embodiments. Each implementation process and implementation in foregoing method embodiments are applied to this terminal embodiment, and a same technical effect can be achieved. For example, FIG. 15 is a schematic diagram of a hardware structure of a terminal according to an embodiment of this application.

A terminal 100 includes, but is not limited to, at least some parts of components such as a radio frequency unit 101, a network module 102, an audio output unit 103, an input unit 104, a sensor 105, a display unit 106, a user input unit 107, an interface unit 108, a memory 109, and a processor 110.

A person skilled in the art may understand that the terminal 100 may further include power supply (such as a battery) for supplying power to the components. The power supply may be logically connected to the processor 110 by a power management system, to implement functions such as charging, discharging, and power consumption management through the power management system. The terminal structure shown in FIG. 15 does not constitute a limitation on the terminal, and the terminal may include more or fewer components than shown, or combine some components, or have different component arrangements. This is not described herein again.

It should be understood that, the input unit 104 may include a Graphics Processing Unit (GPU) 1041 and a microphone 1042. The graphics processing unit 1041 performs processing on image data of a static picture or a video that is obtained by an image acquisition device (for example, a camera) in a video acquisition mode or an image acquisition mode. The display unit 106 may include a display panel 1061, and the display panel 1061 may be configured by using a liquid crystal display, an organic light-emitting diode, or the like. The user input unit 107 includes at least one of a touch panel 1071 and another input device 1072. The touch panel 1071 may also be referred to as a touchscreen. The touch panel 1071 may include two parts, a touch detection apparatus and a touch controller. The another input device 1072 may include, but is not limited to, a physical keyboard, a functional key (such as a volume control key or a switch key), a track ball, a mouse, and a joystick. This is not described herein again.

In this embodiment of this application, after receiving downlink data from a network side device, a radio frequency unit 101 may transmit the downlink data to the processor 110 for processing. In addition, the radio frequency unit 101 may send uplink data to the network side device. Generally, the radio frequency unit 101 includes, but is not limited to, an antenna, an amplifier, a transceiver, a coupler, a low noise amplifier, a duplexer, and the like.

The memory 109 may be configured to store a software program or an instruction and various data. The memory 109 may mainly include a first storage area that stores a program or an instruction and a second storage area that stores data. The first storage area may store an operating system, an application or the instruction required by at least one function (for example, a sound playback function and an image display function), and the like. In addition, the memory 109 may include a volatile memory or a non-volatile memory, or the memory 109 may include both a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDR_SDRAM), an Enhanced SDRAM (ESDRAM), a Synchlink DRAM (SLDRAM), and a Direct Rambus RAM (DRRAM). The memory 109 in this embodiment of this application includes, but is not limited to, the memories and any other memory of a suitable type.

The processor 110 may include one or more processing units. For example, the processor 110 may integrate an application processor and a modem processor. The application processor mainly processes an operation involving technologies operating system, a user interface, an application, and the like. The modem processor mainly processes a wireless communication signal, such as a baseband processor. It may be understood that the foregoing modem may not be integrated into the processor 110.

The radio frequency unit 101 is configured to send N preamble(s) to a first cell when the first cell is a to-be-woken-up cell, where the first cell is different from a serving cell of UE. The processor 110 is configured to determine a first beam based on first information, where the first information is related to the N sent preambles. The processor 110 is configured to transmit data on the first beam.

For example, in this embodiment of this application, the first information includes at least one of the following: a first SSB; a first preamble; timing calibration information; and a cell identifier of the first cell; where the first preamble is a preamble that corresponds to the first SSB in the N preamble(s), the timing calibration information is configured for calibrating time information of a first network side device corresponding to the first cell, and the first network side device is in an energy saving mode.

For example, in this embodiment of this application, the beam selection apparatus 600 further includes the radio frequency unit 101. The radio frequency unit 101 is configured to obtain second information. In some embodiments, the radio frequency unit 101 is configured to send the N preamble(s) to the first cell based on the second information, where the second information is configured through the first cell.

For example, in this embodiment of this application, the second information includes at least one of the following: an SSB configuration of the first cell; a mapping relationship between the SSB of the first cell and the N preamble(s); a PRACH transmission occasion; and a time-frequency resource of the N preamble(s).

For example, in this embodiment of this application, the processor 110 is further configured to determine a time-frequency resource of the N preamble(s) based on the second information. In some embodiments, the radio frequency unit 101 is configured to send the N preamble(s) to the first cell based on the determined time-frequency resource of the N preamble(s).

For example, in this embodiment of this application, the processor 110 is configured to determine a time-frequency resource of the N preamble(s) based on the second information and according to a first rule. The first rule includes at least one of the following: a quantity of to-be-sent preambles is determined based on a quantity of SSBs corresponding to the first cell; and a position of a time-frequency resource of a to-be-sent preamble is determined based on the following content: the quantity of SSBs corresponding to the first cell, a PRACH transmission occasion, a RACH transmission occasion of each SSB corresponding to the first cell, and msg1-FDM.

For example, in this embodiment of this application, the radio frequency unit 101 is configured to obtain the second information sent by a first network side device, where the first network side device is in an energy saving mode.

For example, in this embodiment of this application, the processor 110 is configured to detect a downlink signal after sending each of the preambles. In some embodiments, the processor 110 is configured to determine the first beam based on the signal quality of the detected downlink signal, where the first information includes the signal quality of the downlink signal.

For example, in this embodiment of this application, the radio frequency unit 101 is further configured to re-send the N preamble(s) when a first condition is met, where the first condition includes any one of the following: the UE fails to detect the downlink signal in a first pre-determined time after sending the preamble; and the signal quality of the downlink signal detected by the UE does not meet a pre-determined condition.

For example, in this embodiment of this application, the radio frequency unit 101 is further configured to stop sending the N preamble(s) if the N preamble(s) are repeatedly sent a plurality of times and the downlink signal fails to be detected each time.

For example, in this embodiment of this application, that the UE transmits data on the first beam includes at least one of the following:
monitoring a first PDCCH corresponding to the first beam;
measuring a first SSB or a first RS corresponding to the first beam; and
sending a RACH or a PUCCH on a time-frequency resource corresponding to the first beam.

For example, in this embodiment of this application, the first PDCCH includes a PDCCH for scheduling system information corresponding to the first SSB.

In the terminal provided in this embodiment of this application, the terminal sends the N preamble(s) to the first cell when the first cell is the to-be-woken-up cell, where the first cell is different from a serving cell of the UE; determines the first beam based on the first information, where the first information is related to the N preamble(s); and transmits the data on the first beam. In this way, the UE may send the N preamble(s) to the to-be-woken-up first cell, to obtain the first information and determine the first beam, and then may transmit the data on the first beam, to enable the UE to quickly and establish a beam connection to the to-be-woken-up first cell.

Embodiments of this application further provide a network side device, including a processor and a communication interface. The communication interface is configured to send N preamble(s) to a first cell when the first cell is a to-be-woken-up cell, where the first cell is different from a serving cell of UE. The processor is configured to determine a first beam based on first information, where the first information is related to the N preamble(s). The UE transmits data on the first beam. This network side device embodiment corresponds to foregoing network side device method embodiments. Each implementation process and implementation in foregoing method embodiments are applied to this network side device embodiment, and a same technical effect can be achieved.

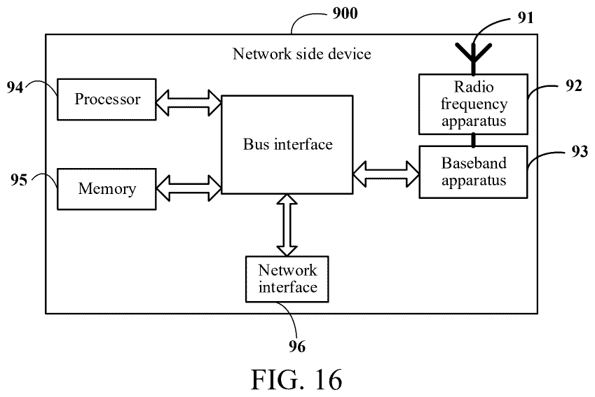

For example, embodiments of this application further provide a network side device. As shown in FIG. 16, a network side device 900 include an antenna 91, a radio frequency apparatus 92, a baseband apparatus 93, a processor 94, and a memory 95. The antenna 91 is connected with the radio frequency apparatus 92. In an uplink direction, the radio frequency apparatus 92 receives information through the antenna 91, and sends the received information to the baseband apparatus 93 for processing. In a downlink direction, the baseband apparatus 93 processes information to be sent, and sends the information to the radio frequency apparatus 92. The radio frequency apparatus 92 processes the received information, and then sends the information through the antenna 91.

The method performed by the network side device in foregoing embodiments may be implemented in the baseband apparatus 93. The baseband apparatus 93 includes a baseband processor.

The baseband apparatus 93, for example, may include at least one baseband board. The baseband board disposes a plurality of chips. As shown in FIG. 16, one chip is the baseband processor, and is connected with the memory 95 through a bus interface, to use a program of the memory 95, and perform network device operations shown in foregoing method embodiments.

The network side device may further include a network interface 96. The interface is, for example, a Common Public Radio Interface (CPRI).

For example, the network side device 900 in this embodiment of the present disclosure further includes an instruction or a program stored in the memory 95 and run on the processor 94. The processor 94 use the instruction or the program stored in the memory 95 to perform the method performed by each module shown in FIG. 7a-FIG. 7d, and a same technical effect is achieved. To avoid repetition, this is not described herein again.

Embodiments of this application further provide a readable storage medium, where the readable storage medium stores a program or an instruction. Each process of the beam selection method is implemented when the program or the instruction is executed by a processor, and a same technical effect can be achieved. To avoid repetition, this is not described herein again.

The processor may be a processor of the terminal in foregoing embodiments. The readable storage medium includes a computer-readable storage medium, for example, a computer read-only memory ROM, a random access memory RAM, magnetic disk, or optical disk

Embodiments of this application further provide a chip. The chip includes a processor and a communication interface. The communication interface is coupled to the processor. The processor is configured to run a program or an instruction, to implement the beam selection method, and a same technical effect can be achieved. To avoid repetition, this is not described herein again.

It should be understood that, the chip mentioned in this embodiment of this application further may be referred to as a system chip, a chip system, a system on chip, or the like.

Embodiments of this application provide a computer program/program product, where the computer program/program product is stored in a storage medium. The computer program/program product is executed by at least one processor to implement each process of the beam selection method, and a same technical effect can be achieved. To avoid repetition, this is not described herein again.

Embodiments of this application further provide a communication system, including a terminal and a network side device. The terminal is configured to perform steps of the beam selection method. The network side device is configured to perform steps of the beam selection method.

It should be noted that the term “include”, “comprise”, or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the processes, methods, objects, or apparatuses. In addition, it should be noted that, a range of the method and the apparatus in embodiments of this application is not limited to perform a function in a sequence shown or discussed, and may further include performing the function based on a related function in a substantially same manner or in a reverse sequence. For example, the function may be performed in the sequence shown or discussed. The described method may be performed in a sequence different from the described method, and various steps may alternatively be added, omitted, or combined. In addition, features described with reference to examples may be combined in other examples.

Through the descriptions of the foregoing implementations, a person skilled in the art may clearly understand that the methods in the foregoing embodiments may be implemented by using software and a necessary general hardware platform, and may alternatively be implemented by hardware, but in many cases, the former manner is a better implementation. Based on such an understanding, the technical solutions of this application essentially or the part contributing to the current art may be implemented in a form of a computer software product. The computer software product is stored in a storage medium (such as a ROM/RAM, a magnetic disk, or an optical disc) and includes several instructions for instructing a terminal (which may be a mobile phone, a computer, a server, an air conditioner, a network device, or the like) to perform the methods described in embodiments of this application.

Embodiments of this application are described above with reference to the accompanying drawings. However, this application is not limited to the foregoing specific implementations. The foregoing specific implementations are illustrative instead of imitative. Enlightened by this application, a person of ordinary skill in the art can make many encloses without departing from the idea of this application and the scope of protection of the claims. All of the encloses fall within the protection of this application.

What is claimed is:

1. A beam selection method, comprising:
sending, by a User Equipment (UE), one or more preambles to a first cell when the first cell is a to-be-woken-up cell, wherein the first cell is different from a serving cell of the UE;
determining, by the UE, a first beam based on first information, wherein the first information is related to the one or more preambles; and
transmitting, by the UE, data on the first beam.

2. The method according to claim 1, wherein the first information comprises at least one of the following:
a first Synchronization Signal Block (SSB);
a first preamble;
timing calibration information; or
a cell identifier of the first cell, wherein the first preamble is a preamble in the one or more preambles that corresponds to the first SSB, the timing calibration information is configured for calibrating time information of a first network side device corresponding to the first cell, and the first network side device is in an energy saving mode.

3. The method according to claim 1, wherein before the sending, by the UE, the one or more preambles to the first cell, the method further comprises:
obtaining, by the UE, second information, and
the sending, by the UE, the one or more preambles to the first cell comprises:
sending, by the UE, the one or more preambles to the first cell based on the second information, wherein the second information is configured through the first cell.

4. The method according to claim 3, wherein the second information comprises at least one of the following:
an SSB configuration of the first cell;
a mapping relationship between an SSB of the first cell and the one or more preambles;
a Physical Random Access Channel (PRACH) transmission occasion; or
a time-frequency resource of the one or more preambles.

5. The method according to claim 3, wherein the sending, by the UE, the one or more preambles to the first cell based on the second information comprises:
determining, by the UE, a time-frequency resource of the one or more preambles based on the second information; and
sending, by the UE, the one or more preambles to the first cell based on the determined time-frequency resource of the one or more preambles.

6. The method according to claim 5, wherein the determining, by the UE, the time-frequency resource of the one or more preambles based on the second information comprises:
determining, by the UE, the time-frequency resource of the one or more preambles based on the second information and according to a first rule, wherein the first rule comprises at least one of the following:
a quantity of at least one to-be-sent preamble is determined based on a quantity of SSBs corresponding to the first cell; or
a position of a time-frequency resource of the at least one to-be-sent preamble is determined based on the following content: the quantity of SSBs corresponding to the first cell, a Physical Random Access Channel (PRACH) transmission occasion, a Random Access Channel (RACH) transmission occasion of each SSB corresponding to the first cell, and msg1-Frequency Division Multiplexing (FDM).

7. The method according to claim 3, wherein the obtaining, by the UE, the second information comprises:
obtaining, by the UE, the second information sent by a first network side device, wherein the first network side device is in an energy saving mode.

8. The method according to claim 1, wherein before the determining, by the UE, the first beam based on the first information, the method further comprises:
detecting, by the UE, a downlink signal after sending each of the preambles, and the determining, by the UE, the first beam based on the first information comprises:
determining, by the UE, the first beam based on signal quality of the detected downlink signal, wherein the first information comprises the signal quality of the downlink signal.

9. The method according to claim 8, further comprising:
re-sending, by the UE, the one or more preambles when a first condition is met, wherein the first condition comprises any one of the following:
the UE fails to detect the downlink signal in a first pre-determined time after sending the preamble; or
the signal quality of the downlink signal detected by the UE does not meet a pre-determined condition.

10. The method according to claim 9, further comprising:
stopping, by the UE, sending the one or more preambles when the UE repeatedly sends the one or more preambles a plurality of times and fails to detect the downlink signal each time.

11. The method according to claim 1, wherein the transmitting, by the UE, the data on the first beam comprises at least one of the following:
monitoring a first Physical Downlink Control Channel (PDCCH) corresponding to the first beam;
measuring a first SSB or a first Reference Signal (RS) corresponding to the first beam; or
sending a Random Access Channel (RACH) or a Physical Uplink Control Channel (PUCCH) on a time-frequency resource corresponding to the first beam.

12. The method according to claim 11, wherein the first PDCCH comprises a PDCCH for scheduling system information corresponding to the first SSB.

13. A beam selection method, comprising:
receiving, by a first network side device, one or more preambles sent by a User Equipment (UE);
determining, by the first network side device, a first beam based on the one or more preambles; and
sending, by the first network side device, first information to a second network side device, wherein
the first information is configured for indicating the first beam, and the first network side device is in an energy saving mode; and
a cell corresponding to the second network side device comprises a serving cell of the UE.

14. The method according to claim 13, wherein the determining, by the first network side device, the first beam based on the one or more preambles comprises:
determining, by the first network side device, the first beam based on channel quality of a transmission channel of the one or more preambles.

15. The method according to claim 13, wherein the first information comprises at least one of the following:
a first Synchronization Signal Block (SSB);
a first preamble;
timing calibration information; or
a cell identifier of a first cell, wherein
the first cell is a cell to be woken up by the UE in a cell corresponding to the first network side device;
the first preamble is a preamble in the one or more preambles that corresponds to the first SSB; and
the timing calibration information is configured for calibrating time information of the first network side device corresponding to the first cell.

16. The method according to claim 13, wherein before the receiving, by the first network side device, the one or more preambles sent by UE, the method further comprises:
configuring, by the first network side device, second information for the UE, wherein the second information comprises at least one of the following:
an SSB configuration of the first cell;
a mapping relationship between an SSB of the first cell and the one or more preambles;
a Physical Random Access Channel (PRACH) transmission occasion; or
a time-frequency resource of the one or more preambles.

17. The method according to claim 13, wherein after the sending, by the first network side device, the first information to the second network side device, the method further comprises:
receiving, by the first network side device, a wake-up signal sent by the UE on a time-frequency resource corresponding to the first beam, wherein
the wake-up signal comprises at least one of the following:
a preamble of the first beam; or
a Physical Uplink Control Channel (PUCCH) of the first beam.

18. A User Equipment (UE), comprising a processor and a memory storing instructions, wherein the instructions, when executed by the processor, cause the processor to perform operations comprising:
sending one or more preambles to a first cell when the first cell is a to-be-woken-up cell, wherein the first cell is different from a serving cell of the UE;
determining a first beam based on first information, wherein the first information is related to the one or more preambles; and
transmitting data on the first beam.

19. The UE according to claim 18, wherein the first information comprises at least one of the following:
a first Synchronization Signal Block (SSB);
a first preamble;
timing calibration information; or
a cell identifier of the first cell, wherein the first preamble is a preamble in the one or more preambles that corresponds to the first SSB, the timing calibration information is configured for calibrating time information of a first network side device corresponding to the first cell, and the first network side device is in an energy saving mode.

20. A network side device, comprising a processor and a memory storing instructions, wherein the instructions, when executed by the processor, cause the processor to perform the beam selection method according to claim 13.
